(19) United States
(12) Patent Application Publication
(10) Pub. No.: US 2004/0165595 A1
(43) Pub. Date: Aug. 26, 2004

(54) Discovery and integrity testing method in an ethernet domain

(75) Inventors: Stephen L. Holmgren, Little Silver, NJ (US); David Kinsky, High Bridge, NJ (US); Mateusz W. Szela, Hillsborough, NJ (US)

Correspondence Address: AT&T CORP., P.O. BOX 4110, MIDDLETOWN, NJ, 07748, US

(73) Assignee: AT&T Corp., New York, NY (US)

(21) Appl. No.: 10/248,858

(22) Filed: Feb. 25, 2003

(51) Int. Cl. H04L 12/66

(52) U.S. Cl. 370/395.3; 370/241.1

(57) ABSTRACT

The present invention is directed to novel mechanisms for discovery and integrity testing in an Ethernet domain that can span one or more Ethernet service providers.

### CROSS-REFERENCE TO RELATED APPLICATIONS

### REFERENCED-APPLICATIONS

This application is related to U.S. Utility patent application, “FAILURE NOTIFICATION METHOD AND SYSTEM IN AN ETHERNET DOMAIN,” Ser. No. 10/248,761, filed on Feb. 14, 2003.

### BACKGROUND OF INVENTION

The present invention relates to Ethernet networks and, more particularly, to operations, administration, management in an Ethernet based network.

There exists a large embedded base of Local Area Networks (LANs) based on an Ethernet architecture, i.e., the IEEE 802.3 carrier-sense multiple access standard. See, e.g., IEEE Std. 802-1990, “IEEE Standards for Local and Metropolitan Access Networks: Overview and Architecture,” IEEE Std 802.3, “Carrier Sense Multiple Access with Collision Detection (CSMA/CD) Access Method and Physical Layer Specification” (1998 Ed.). Advances in high-speed Ethernet technology have led to the development of Metropolitan Area Networks (MANs), operated and maintained by Ethernet service providers (ESPs), which offer significant cost advantages on a per port basis as compared to competing architectures. Managing customers in an Ethernet domain, however, poses serious challenges. No alert capabilities are provided for remote failures in an Ethernet domain; traditional Ethernet switches only know the status of what is immediately connected to them. Recently, the IEEE 802.3 Working Group has proposed the 802.3ah “Ethernet in the First Mile (EFM)” draft standards on utilizing Ethernet as the basis for subscriber access networks—including proposed protocol extensions to support Operations, Administration, and Maintenance (OAM).

These OAM protocol extensions, unfortunately, to the knowledge of the inventors, have only been described in point-to-point environments. The problem of managing entities in an Ethernet domain that spans one or more Ethernet service providers—and, moreover, that involves endpoints tagged (and untagged) with Virtual Local Access Network (VLAN) identifiers (e.g., utilizing IEEE 802.1Q protocol headers)—has not been addressed.

### SUMMARY OF INVENTION

The present invention is directed to novel mechanisms for discovery and integrity testing in an Ethernet domain that can span one or more Ethernet service providers. In accordance with an aspect of the invention, Ethernet configuration information at a node in the Ethernet domain is advantageously discoverable utilizing new mechanisms at a remote node—which may be under the supervision of a different service provider. A request for virtual local area network configuration information can be issued by an Ethernet node across a tagged link to an adjacent node, the adjacent node returning a response with a data field containing the virtual local area networks configured on the link. The information can be utilized as a sanity check, enabling an Ethernet node to verify that the shared trunk between the two nodes has the correct virtual local area network configuration on both sides. In accordance with another embodiment of this aspect of the invention, a special virtual local area network message request can be broadcast to all remote stations in the Ethernet domain belonging to the virtual local area network. The remote stations respond to the request by including Ethernet configuration information, e.g., the host's media access control (MAC) address, in a message response directed back to the address of the Ethernet node that issued the request. Where the messages must traverse an untagged boundary in the Ethernet domain, for example at links to customer routers, the virtual local area network messages can be translated into a standard protocol data unit that does not utilize the virtual local area network tagging. Likewise, when an untagged message must traverse a tagged boundary in the Ethernet domain, the message can be translated into a corresponding virtual local area network message.

In accordance with another aspect of the invention, mechanisms are provided for that permit an Ethernet station to test the integrity of a connection to a remote station in the Ethernet domain, even where a host exists in a virtual local area network tagged environment. Where the remote media access control address is known, a host in a virtual local area network tagged domain can verify connectivity to the remote host by sending a “ping” request directed to the remote host's media access control address.

The media access control address ping request (and the reply) can utilize a virtual local area network format that is translated into a standard protocol data unit where the messages reach an untagged boundary. In accordance with another embodiment of this aspect of the invention, a host can compute the round trip delay to the remote host by sending a special round trip delay request. The host starts a clock when it issues the round trip delay request and includes an identifier in the request. The remote host sends a round trip delay reply back to the host which includes the identifier. When the host receives the reply, it recognizes the identifier and stops the clock to calculate the round trip delay. In accordance with another embodiment of this aspect of the invention, a host can request that a remote station do a loopback. The host generates a specific data stream which the remote station loops back to the host. The local station can then compare the sent data with the received data. As in the other embodiments, a loopback request or a round trip delay request can be issued in a virtual local area network format that is translated into an untagged format when traversing an untagged boundary.

The present invention advantageously can provide enhanced operations, administration, management in an Ethernet domain—even where the Ethernet domain spans one or more Ethernet service providers and/or involves end points that are tagged or untagged with virtual local area network protocol headers. These and other advantages of the invention will be apparent to those of ordinary skill in the art by reference to the following detailed description and the accompanying drawings.

### BRIEF DESCRIPTION OF DRAWINGS

FIG. 1 is a diagram of a network, used to illustrate an embodiment of the invention.

FIGS. 2A and 2B are protocol structures useful for implementing an embodiment of the invention.

FIG. 3 illustrates virtual local area network configuration discovery, in accordance with an embodiment of the invention.

FIG. 4 illustrates remote station MAC address discovery, in accordance with an embodiment of the invention.

FIG. 5 illustrates a MAC address ping, in accordance with an embodiment of the invention.

FIG. 6 illustrates round trip delay measurement, in accordance with an embodiment of the invention.

FIG. 7 illustrates remote MAC address loopback, in accordance with an embodiment of the invention.

### DETAILED DESCRIPTION

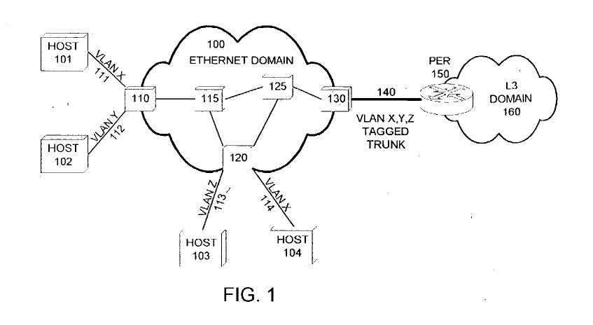

FIG. 1 is a schematic diagram of a network, used to illustrate an embodiment of the invention in FIG. 1, an Ethernet domain 100 is shown that provides network services to a plurality of customers and/or customer sites. The Ethernet domain 100 comprises a plurality of layer two nodes, shown in FIG. 1 as Ethernet switches 110, 115, 120, 125, 130. The Ethernet domain 100 operates at layer two in the well-known seven-layer OSI model and serves to connect a plurality of hosts 101, 102, 103, 104. The hosts 101, 102, 103, 104 in the Ethernet domain can be end stations, servers, gateways, routers, or any other advantageous device with a media access control (MAC) address. For illustration purposes, FIG. 1 only shows four hosts 101, 102, 103, 104 although any number of customer endpoints and customer sites may be shown connected to the Ethernet domain 100.

The Ethernet domain 100 can be utilized by Ethernet service providers to provide the hosts with access to a high speed packet network, e.g. using the network edge node 150 shown in FIG. 1. In FIG. 1, network edge node 150 is a provider edge router (PER) which facilitates access to a layer three Internet Protocol domain 160. It is advantageous to utilize the concept of a “virtual local area network” (VLAN) as a point-to-point unique customer identifier in the Ethernet domain—similar to the concept of a permanent virtual circuit in wide area network-based protocols such as Frame Relay and ATM. See, e.g., U.S. Utility patent application, “TECHNIQUE FOR ETHERNET ACCESS TO PACKET-BASED SERVICES”, Ser. No. 09/772,360, filed on Jan. 30, 2001, and Ser. No. 10/001,545, filed on Oct. 31, 2001, the contents of which are incorporated by reference herein. For example, in FIG. 1, hosts 101 and 104 belongs to one virtual local area network, namely VLAN “X” while host 102 is associated with VLAN “Y.” Likewise, host 103 is associated with VLAN “Z.” Traffic in the Ethernet domain 100 can be tagged with a VLAN identifier, in accordance with known standards for virtual bridged LANs. See, e.g., IEEE Std 802.1Q-1998, “Virtual Bridged Local Area Networks,” Traffic between the hosts 101, 102, 103, 104 and the Ethernet switches 110, 120 can be tagged or untagged. The provider edge router 150 has multiple sub-interfaces: one for each virtual local area network in the Ethernet domain 100. The link 140 between Ethernet switch 130 and the provider edge router 150 is an 802.1Q VLAN tagged trunk. Thus, traffic from a particular customer site can be readily sent to other sites of the same customer within the Ethernet domain 100 by appropriately setting a VLAN tag in each Ethernet frame.

The Ethernet domain 100 is not limited to a single Ethernet service provider and, for purposes of the present invention, may consist of multiple Ethernet service providers (ESPs). In such a case, the layer two device “facing” the provider edge router 150, namely switch 130 in FIG. 1, would aggregate traffic from multiple Ethernet service providers.

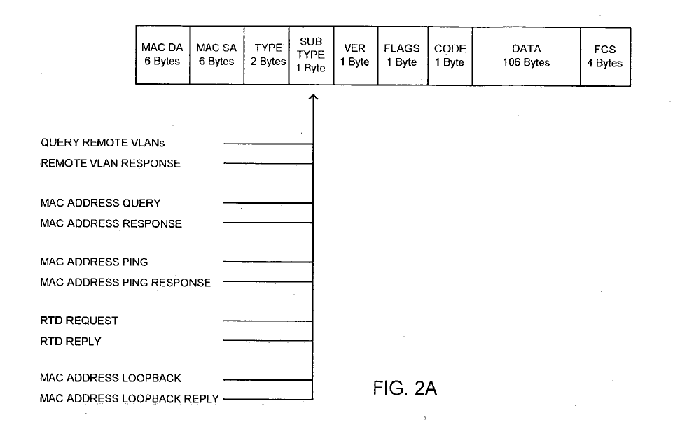

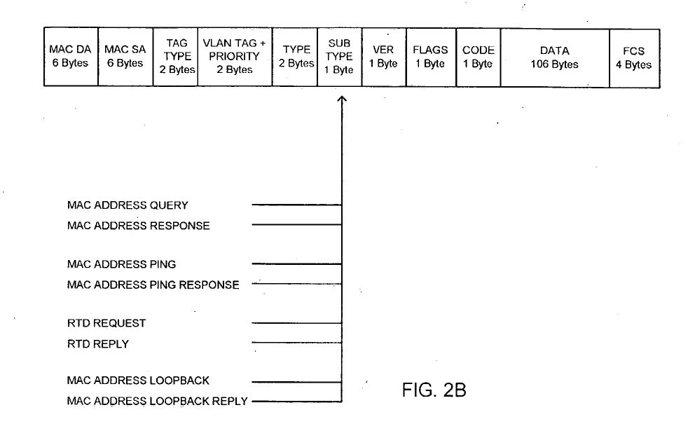

It is assumed below, for illustration purposes, that the Ethernet frames follow the standard Ethernet II protocol data unit (PDU) and that the Ethernet frames, where VLAN tagging is enabled, follow the standard 802.1Q PDU. It is also assumed that the proposed 802.3ah Ethernet OAM PDU, as well as the relevant functionality in the Ethernet hardware, has been settled and adopted. In accordance with an embodiment of an aspect of the invention, the protocol structure is further enhanced to provide for advantageous OAM capabilities and for virtual local area network tag capabilities, as illustrated in FIGS. 2A and 2B. The operation of each sub-type/code shown in FIGS. 2A and 2B is further described herein with reference to each respective OAM activity.

1. DISCOVERY

It is advantageous to provide-mechanisms enabling a node in a VLAN tagged Ethernet domain to discover Ethernet configuration information from a remote node in the domain—in particular where the remote node may be under the supervision and administration of a different service provider.

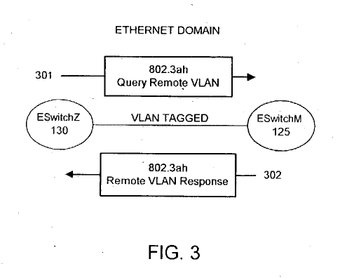

FIG. 3 illustrates virtual local area network configuration discovery, in accordance with a preferred embodiment of this aspect of the invention. An Ethernet switch, namely “ESwitchZ” 130, desires to determine the VLAN configuration of an adjacent switch, namely “ESwitchM” 125 in FIG. 3. The Ethernet switch 130 sends a VLAN configuration query to the adjacent switch, at 301, using a normal Ethernet protocol data unit in OAM packet across the tagged link. Since this is a point to-point scenario and doesn't require VLAN tagging, it is possible to utilize the 802.3ah protocol data unit and create a new sub-type called “QUERY REMOTE VLANs”, as illustrated in FIG. 2A. The adjacent switch 125 would receive the query requesting which VLANs are configured on the shared link. The adjacent switch, at 302, would return a similarly formatted 802.3ah protocol data unit with a sub-type “REMOTE VLAN RESPONSE” and a data field containing a list of the VLANs configured on the link. Where the VLAN configuration received from the adjacent switch 125 is inconsistent with the VLAN configuration information at the switch 130, an alarm can be generated in some automated fashion, for example,-where a VLAN has been deleted on a trunk.

This discovery mechanism provides a useful sanity check that enables the Ethernet switch 130 to verify that the shared trunk between it and the adjacent switch 125 has the correct VLAN configuration on both sides. This embodiment of the present invention provides a powerful tool for detecting incorrect configurations as well as general troubleshooting, in particular in a setting with multiple service providers—where a given provider does not have complete access to another provider's switch hardware.

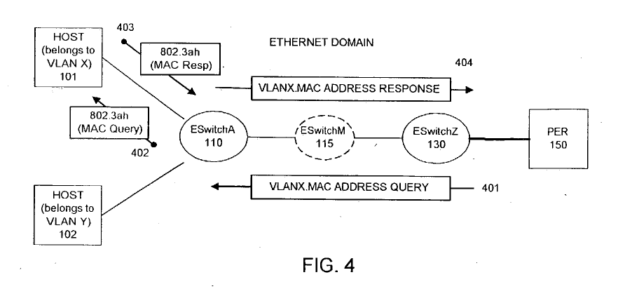

FIG. 4 illustrates discovery of a remote station's configuration information, e.g. its MAC address, in accordance with a preferred embodiment of another aspect of the invention. A station in the Ethernet domain, e.g. the provider edge router 150 in FIG. 4, desires to determine the Ethernet MAC addresses of remote stations attached to the Ethernet domain. At 401, the provider edge router 150 sends a VLAN-tagged OAM packet, the OAM sub-type of the message being “MAC ADDRESS QUERY.” The destination address (DA) in the packet would preferably be a broadcast address (e.g., all “1”s) or some sort of multicast address. In this manner, all Ethernet switches between the provider edge router 150 and hosts in the Ethernet domain, e.g. Ethernet switches 110, 115, 120 shown in FIG. 4, would simply forward the packet. When the packet reaches Ethernet switch 110, just prior to handing off to host equipment 101, 102, the VLAN tag information can be stripped off where the host links are untagged. At 402, an OAM packet that resembles an 802.3ah protocol data unit with a new sub-type “MAC ADDRESS QUERY” would be sent to the host 101. Where the host links are tagged, the VLAN-tagged packet may be forwarded by the Ethernet switch 110 directly to the host 101. The host 101 receives the packet and processes the request by constructing a reply packet. Where the host 101 has an untagged link, as shown in FIG. 4, the host 101 replies with an 802.3ah protocol data unit with a sub-type of “MAC ADDRESS RESPONSE” and formatted with the provider edge router's MAC address as the destination address. This address was obtained when the host 101 received the OAM packet. The OAM packet response will also include, as the source address, the MAC address of the host 101. Alternatively, the OAM packet response can include some other Ethernet configuration information in a data field. When the reply reaches the Ethernet switch 110, the switch 110 can encapsulate it into a VLAN format and forward it back towards the provider edge router 150. On the other hand, where the host has a tagged link, the response packet can use a comparable VLAN-tagged format, which would be forwarded back without a need for changing the protocol data unit format. Accordingly, the provider edge router 150 will then be able to collect OAM packet responses from all of the remote stations receiving the MAC address query. This is particularly advantageous where the remote stations may be under the administration of customers or other service providers, separate from the entity supervising the provider edge router.

2. INTEGRITY TESTING

It is advantageous to provide mechanisms enabling a station in the Ethernet domain to test the integrity of a connection to a remote station—in particular, in a multi-service provider environment utilizing VLAN tagging. It is assumed for the following that the remote station's MAC address is already known. Either host advantageously can have a tagged or untagged link, although for purposes of the following illustrations the hosts are shown as having untagged links.

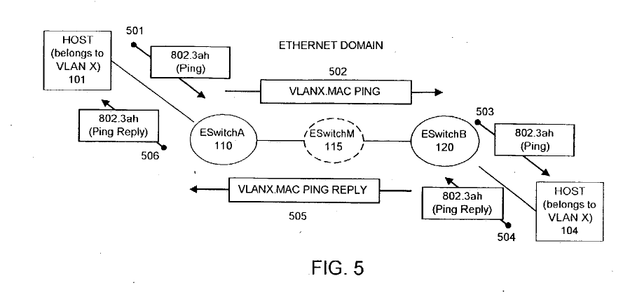

FIG. 5 illustrates a simple MAC address “ping”, in accordance with a preferred embodiment of this aspect of the invention. Host 101 in the VLAN tagged domain wants to verify connectivity to another known Ethernet MAC address host, namely host 104 in FIG. 5. Accordingly, host 101 sends a MAC address ping Ethernet packet at 501. Where the host 101 has an untagged link, as shown in FIG. 5, the host 101 can use an 802.3ah protocol data unit, with a sub-type of “MAC ADDRESS PING” as shown in FIG. 2A. At an Ethernet switch 110 at the VLAN tagged boundary, this message is translated and retransmitted in the VLAN tagged format shown in FIG. 2B. Where the host 101 has a tagged link, there is no need for this step: the host can simply send the MAC address ping utilizing the VLAN tagged protocol data unit shown in FIG. 2B. At 502, the VLAN tagged MAC address ping is forwarded by any number of intermediate switches 115 to an Ethernet switch 120 with a link to the host 104 with the MAC address identified in the MAC address ping request. Where the host 104 has an untagged link, the MAC address ping is translated into an 802.3ah protocol data unit by the switch 120 and forwarded to the host 104 at 503. If not, then the MAC address ping can be immediately forwarded to the host 104. The host 104 receives the MAC address ping request, and proceeds to construct a response in the form of a MAC address ping reply using the MAC address of the host 101 as the destination. Where the host 104 has an untagged link, as shown in FIG. 5 at 504, the host 104 forwards the response as an 802.3ah protocol data unit, with a sub-type of “MAC ADDRESS PING RESPONSE” as shown in FIG. 2A. The Ethernet switch 120 translates and retransmits the message in a VLAN tagged format, as shown in FIG. 2B. Again, where the host 104 has a tagged link, there is not need for this step, and the host 104 can simply send the MAC address ping reply utilizing the VLAN tagged protocol data unit. The VLAN tagged MAC address ping reply is forwarded, at 505, back to the Ethernet switch 110, where the message is translated and retransmitted as an 802.3ah protocol data unit if the host 101 has an untagged link to the switch 110. If not, then the VLAN tagged MAC address ping reply can be forwarded directly to the host 101.

Thus, similarly to the IP datagram context, if the host 101 receives the MAC address ping reply, it knows that there is layer two connectivity to the host with the MAC address identified in the MAC address ping. Moreover, the MAC address ping request works in a VLAN tagged and untagged environment.

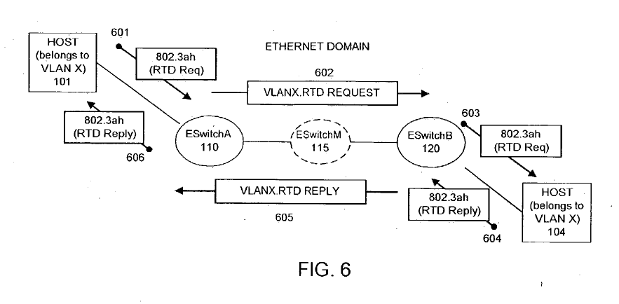

FIG. 6 illustrates another form of integrity testing, enabling a host to measure the round trip delay to a remote host, in accordance with a preferred embodiment of this aspect of the invention. Host 101 in the VLAN tagged domain shown in FIG. 6 wants to measure the time it takes for an Ethernet packet to reach a particular MAC address, namely host 104, and return back to the host 101. Accordingly, at 601, the host 101 sends a round trip delay (RTD) request containing some form of identifier, such as a unique integer. The host 101 simultaneously starts a timer that is associated with the identifier. Where the host 101 has an untagged link, as shown in FIG. 6, the host 101 can use an 802.3ah protocol data unit, with a sub-type of “RTD REQUEST” as shown in FIG. 2A. At an Ethernet switch 110 at the VLAN tagged boundary, this message is translated and retransmitted in the VLAN tagged format shown in FIG. 2B. Where the host 101 has a tagged link, there is no need for this step: the host can simply send the RTD request utilizing the VLAN tagged protocol data unit shown in FIG. 2B. At 602, the VLAN tagged RTD request is forwarded by any number of intermediate switches 115 to an Ethernet switch 120 with a link to the host 104 with the MAC address identified in the RTD request. Where the host 104 has an untagged link, the RTD request is translated into an 802.3ah protocol data unit by the switch 120 and forwarded to the host 104 at 603. If not, then the RTD request can be immediately forwarded to the host 104. The host 104 receives the RTD request, and processes the request by replying with an RTD reply using the same identifier and the MAC address of the host 101 as the destination. Where the host 104 has an untagged link, as shown in FIG. 6 at 604, the host 104 forwards the response as an 802.3ah protocol data unit, with a sub-type of “RTD REPLY” as shown in FIG. 2A. The Ethernet switch 120 translates and retransmits the message in a VLAN tagged format, as shown in 2B. Again, where the host 104 has a tagged link, there is no need for this step, and the host 104 can simply send the RTD reply utilizing the VLAN tagged protocol data unit. The VLAN tagged RTD reply is forwarded, at 605, back to the Ethernet switch 110, where the message is translated and retransmitted as an 802.3ah protocol data unit if the host 101 has an untagged link to the switch 110. If not, then the VLAN tagged RTD reply can be forwarded directly to the host 101. The host 101 receives the RTD reply and, using the identifier in the RTD reply, stops the corresponding timer to compute the round trip delay time.

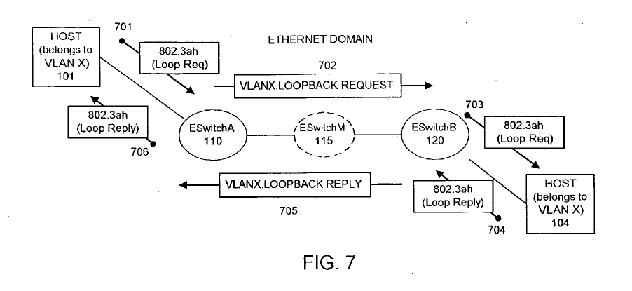

FIG. 7 illustrates another form of integrity testing, enabling a loopback from a remote host, in accordance with a preferred embodiment of this aspect of the invention. Host 101 in the VLAN tagged domain shown in FIG. 7 wants to request that the host at a particular MAC address, namely host 104 in FIG. 7, perform a loopback of a particular data stream. Accordingly, at 701, the host 101 sends a loopback request and generates a specific data stream for the loopback request. The data stream can be included in the payload of the loopback request and/or can be included in subsequent packets sent to the host 104. Where the host 101 has an untagged link, as shown in FIG. 7, the host 101 can use an 802.3ah protocol data unit, with a sub-type of “MAC ADDRESS LOOPBACK” as shown in FIG. 2A. At an Ethernet switch 110 at the VLAN tagged boundary, this message is translated and retransmitted in the VLAN tagged format shown in FIG. 2B. Where the host 101 has a tagged link, there is no need for this step: the host can simply send the loopback request utilizing the VLAN tagged protocol data unit shown in FIG. 2B. At 702, the VLAN tagged loopback request is forwarded by any number of intermediate switches 115 to an Ethernet switch 120 with a link to the host 104 with the MAC address identified in the loopback request. Where the host 104 has an untagged link, the loopback request is translated into an 802.3ah protocol data unit by the switch 120 and forwarded to the host 104 at 703. If not, then the loopback request can be immediately forwarded to the host 104. The host 104 receives the loopback request, and processes the request by simply looping the data stream back to the host 101. Where the host 104 has an untagged link, as shown in FIG. 7 at 704, the host 104 forwards the response as an 802.3ah protocol data unit, preferably with a sub-type of “MAC ADDRESS LOOPBACK REPLY” as shown in FIG. 2A. The Ethernet switch 120 translates and retransmits the message in a VLAN tagged format, as shown in FIG. 2B. Again, where the host 104 has a tagged link, there is no need for this step, and the host 104 can simply send the loopback reply utilizing the VLAN tagged protocol data unit. The VLAN tagged loopback reply is forwarded, at 705, back to the Ethernet switch 110, where the message is translated and retransmitted as an 802.3ah protocol data unit if the host 101 has an untagged link to the switch 110. If not, then the VLAN tagged loopback reply can be forwarded directly to the host 101. The host 101 receives the loopback reply and can compare the original data stream sent out with the received data stream.

It should be noted that this last testing mechanism would be intrusive to normal data patterns. Nevertheless, since the packets would only contain layer two information, there advantageously would be no leakage into other network clouds.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description describes an embodiment of the invention with particular reference to Ethernet based architectures. However, the principles of the present invention could be readily extended to other broadcast layer two protocols. Such an extension could be readily implemented by one of ordinary skill in the art given the above disclosure.

1. A method of administering an ethernet domain, the method comprising the steps of:
sending a query from a first Ethernet node in the Ethernet domain to a second Ethernet node in the Ethernet domain, the query requesting virtual local area network configuration information from the second Ethernet node;
receiving a response from the second Ethernet node, the response comprising the virtual local area network configuration information which further comprises a data field containing information on virtual local area networks configured on a shared tagged link between the first Ethernet node and the second Ethernet node.

2. The method of claim 1 further comprising the step of verifying that the virtual local area network configuration information from the second Ethernet node is consistent with virtual local area network configuration information at the first Ethernet node.

3. The method of claim 2 wherein the query and the response are point to point messages that do not utilize virtual local area network tagging.

4. The method of claim 3 wherein the first and second Ethernet nodes are operated by different service providers.

5. A method of administering an Ethernet domain, the method comprising the steps of:
broadcasting a query in a virtual local area network format to one or more stations connected to an Ethernet domain, the query requesting Ethernet configuration information from the stations; and
receiving responses from the stations, the response comprising a data field containing the Ethernet configuration information from the stations and where the query must traverse an untagged boundary of the Ethernet domain, translating the query from the virtual local area network format into a protocol data unit that does not utilize virtual local area network tagging.

6. The method of claim 5 wherein the Ethernet configuration information is a media access control address.

7. A method of administering an Ethernet domain, the method comprising the steps of:
receiving an OAM request from a first host in the Ethernet domain addressed to a second host in the Ethernet domain;
where the OAM request is traversing a tagged boundary in the Ethernet domain, encapsulating the OAM request in a virtual local area network format;
where the OAM request is traversing an untagged boundary in the Ethernet domain, translating the OAM request from the virtual local area network format into a protocol data unit that does not utilize virtual local area network tagging; and
forwarding the OAM request towards the second host in the Ethernet domain.

8. The method of claim 7 wherein the OAM request is a media access control address ping request.

9. The method of claim 7 wherein the OAM request is a round trip delay request.

10. The method of claim 7 wherein the OAM request is a loopback request.
